(19) United States
(12) Patent Application Publication
(10) Pub. No.: US 2020/0096141 A1
(43) Pub. Date: Mar. 26, 2020

(54) CONNECTING DEVICE

(71) Applicant: Bong Kwan KIM, Jinju-si, Gyeongsangnam-do (KR)

(72) Inventor: Bong Kwan KIM, Jinju-si, Gyeongsangnam-do (KR)

(21) Appl. No.: 16/481,062

(22) PCT Filed: Mar. 6, 2018
(86) PCT No.: PCT/KR2018/002656

§ 371 Date: Jul. 25, 2019

(30) Foreign Application Priority Data
Nov. 30, 2017 (KR) 10-2017-0162367

(51) Int. Cl. F16L 19/07; F16L 37/092; F16L 37/12

(52) U.S. Cl. CPC F16L 19/07; F16L 37/123; F16L 37/092

(57) ABSTRACT

Disclosed is a connecting device including a connecting portion provided such that a pipe is insertable thereinto, a pressurizing portion configured to deform the connecting portion by pressurizing the connecting portion, a fixing portion mounted on the connecting portion, moved by the pipe when the pipe is inserted into the connecting portion, and configured to come into contact with the pipe, and a supporting portion configured to pressurize the fixing portion such that the fixing portion restricts movement of the pipe.

### TECHNICAL FIELD

The present invention relates to a connecting device, and more particularly, to a connecting device capable of connecting a pipe and the like through a simple operation.

### BACKGROUND ART

Generally, a connecting device applied to connecting a hose, a pipe, a tube, or the like corresponds to a device configured to extend a length of a pipe and the like including a hose, tube, and the like, or to control movement of a fluid through a connecting device.

However, in a conventional connecting device, due to complicated components thereof, manufacturing costs are high, manufacturing is difficult, and a method of assembling a pipe and the like is complicated such that there are inconveniencies in use. Accordingly, it is necessary to make improvements thereto.

A related art of the present invention is disclosed in Korean Utility Model Publication No. 20-2017-0002668 (published on Jul. 26, 2017 and titled: Pipe connecting device).

### DISCLOSURE

### Technical Problem

The present invention is directed to providing a connecting device configured to have a simple configuration and to connect a pipe and the like through a simple operation.

### Technical Solution

One aspect of the present invention provides a connecting device including a connecting portion provided such that a pipe is insertable thereinto, a pressurizing portion configured to deform the connecting portion by pressurizing the connecting portion, a fixing portion mounted on the connecting portion, moved by the pipe when the pipe is inserted into the connecting portion, and configured to come into contact with the pipe, and a supporting portion configured to pressurize the fixing portion such that the fixing portion restricts movement of the pipe.

The connecting portion may include a connecting body portion, which includes a space portion therein and is connected to the pipe, and a connecting-pressurizing portion coupled with the connecting body portion, on which the fixing portion is mounted, deformed according to coupling with the pressurizing portion, and formed such that an inner diameter of the fixing portion extends as the fixing portion moves in a direction in which the pipe enters.

The connecting-pressurizing portion may include a plurality of connecting-pressurizing portion bodies, which are disposed to be spaced apart, on which the fixing portion is mounted. Also, the connecting-pressurizing portion body may be provided such that an interval from another connecting-pressurizing portion body adjacent thereto varies according to a degree of the pressurizing portion moving.

The connecting-pressurizing portion may further include a pressurizing protrusion protruding outward from the connecting-pressurizing portion body and may move the connecting-pressurizing portion body inward when the pressurizing protrusion is pressurized according to movement of the pressurizing portion.

The pressurizing protrusions may be equidistantly arranged in a circumferential direction on the basis of a central axis of the fixing portion or the supporting portion.

The fixing portion may be provided to be movable at the connecting-pressurizing portion, may protrude from the connecting-pressurizing portion, and may come into contact with the pipe.

The fixing portion may include a fixing-moving portion movably provided at the connecting-pressurizing portion and pressurized by the supporting portion and a pipe-contacting portion protruding from the fixing-moving portion and coming into contact with an outer circumferential surface of the pipe.

The pipe-contacting portion may include a pipe-contacting protrusion portion formed to protrude from a surface facing the pipe and may come into contact with the pipe.

The connecting-pressurizing portion may include a fixing portion accommodating portion, in which the fixing-moving portion is movable and through which the fixing portion passes, and an accommodating cover portion coupled with the fixing portion accommodating portion and configured to prevent the fixing portion from being separated from the fixing portion accommodating portion.

The fixing portion may include a convex surface coming into contact with the pipe and formed as a curved surface.

A thickness of the fixing portion may be formed to increase in a direction in which the pipe enters.

The fixing portion and the supporting portion may be integrally formed. The fixing portion and the supporting portion may be formed to separately have a coil shape.

The supporting portion may pressurize the fixing portion in a direction opposite to the direction in which the pipe enters into the fixing portion.

### Advantageous Effects

A connecting device according to the present invention is implemented as a simple configuration such that manufacturing is easy, costs thereof are low, and a pipe and the like is attachable or detachable through a simple operation.

Also, the connecting device according to the present invention may connect pipes without changing a component and the like even when diameters of the pipes differ from each other and may stably and firmly fix the pipes using an incline of a connecting portion, a wedge action of a fixing portion, and the like.

Also, the connecting device according to the present invention may easily separate pipes by simply disassembling a pressurizing portion.

### DESCRIPTION OF DRAWINGS

FIG. 1 is an exploded view schematically illustrating a connecting device according to a first embodiment of the present invention.

FIG. 2 is a view illustrating a state before a pipe according to the first embodiment of the present invention is inserted into a fixing portion.

FIG. 3 is a view illustrating a state in which the pipe according to the first embodiment of the present invention enters a connecting portion while pushing the fixing portion.

FIG. 4 is a view illustrating a state in which the pipe according to the first embodiment of the present invention is inserted in the fixing portion.

FIG. 5 is a cross-section view illustrating before and after a connecting-pressurizing portion according to the first embodiment of the present invention is pressurized by a pressurizing portion.

FIG. 6 is an exploded view schematically illustrating a connecting device according to a second embodiment of the present invention.

FIG. 7 is a view illustrating a state before a pipe according to the second embodiment of the present invention is inserted into a fixing portion.

FIG. 8 is a view illustrating a state in which the pipe according to the second embodiment of the present invention enters a connecting portion while pushing the fixing portion.

FIG. 9 is a view illustrating a state in which the pipe according to the second embodiment of the present invention is inserted in the fixing portion.

FIG. 10 is a view schematically illustrating a state in which a fixing portion and a supporting portion which are separably provided in a connecting device according to a third embodiment of the present invention are mounted on a connecting portion.

FIG. 11 is a configuration diagram illustrating the fixing portion and the supporting portion which are separably provided in the connecting device according to the third embodiment of the present invention and the connecting portion.

FIG. 12 is a view illustrating a case in which the fixing portion of the connecting device according to the third embodiment of the present invention is spherical.

FIG. 13 is a configuration diagram schematically illustrating a connecting device according to a fourth embodiment of the present invention.

FIG. 14 is a view illustrating a state in which a pipe is inserted in a fixing portion in the connecting device according to the fourth embodiment of the present invention.

FIG. 15 is a view illustrating a state in which a pressuring portion pressurizes a pressurizing protrusion in the connecting device according to the fourth embodiment of the present invention.

FIG. 16 is a cross-section view illustrating before and after a connecting-pressurizing portion according to the fourth embodiment of the present invention is pressurized by the pressurizing portion.

### MODES OF THE INVENTION

Hereinafter, embodiments of a connecting device according to the present invention will be described with reference to the attached drawings. In this process, a thickness of lines, a size of a component, or the like shown in the drawings may be exaggerated for clarity and convenience of description.

Also, the following terms are defined in consideration of functions thereof in the present invention and may vary according to the intention of a user or an operator or practice. Accordingly, definitions of the terms will be determined on the basis of the content throughout the specification.

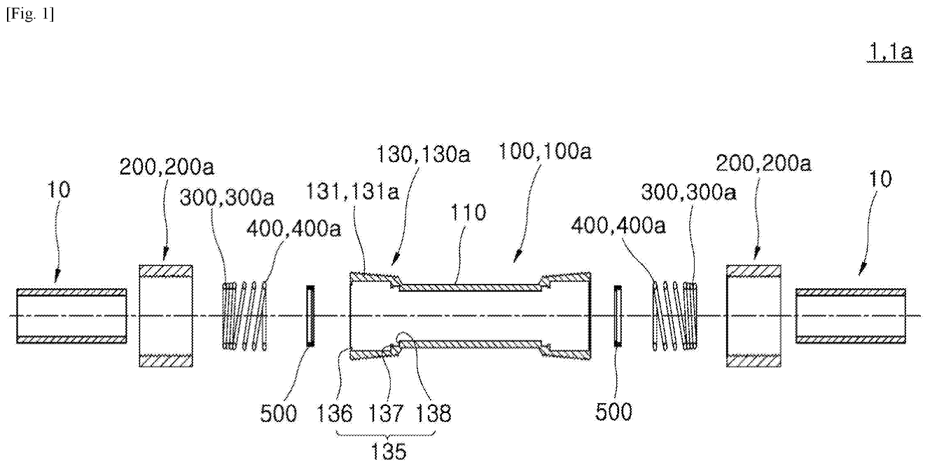

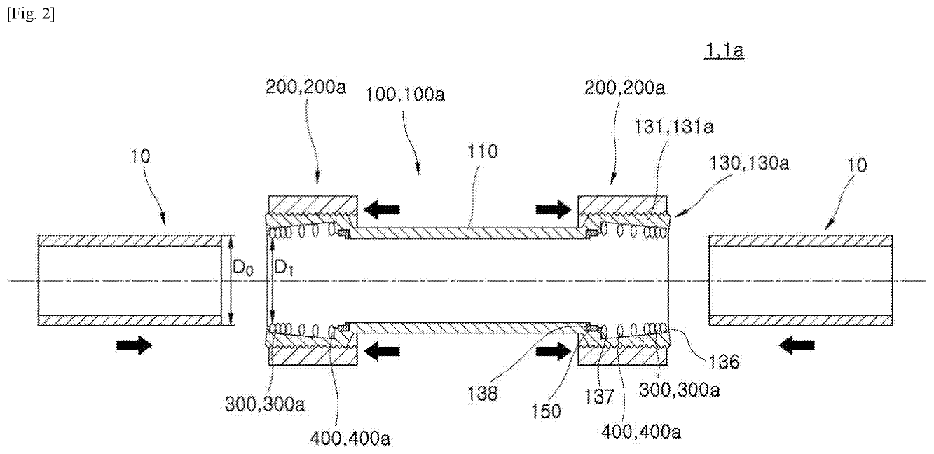

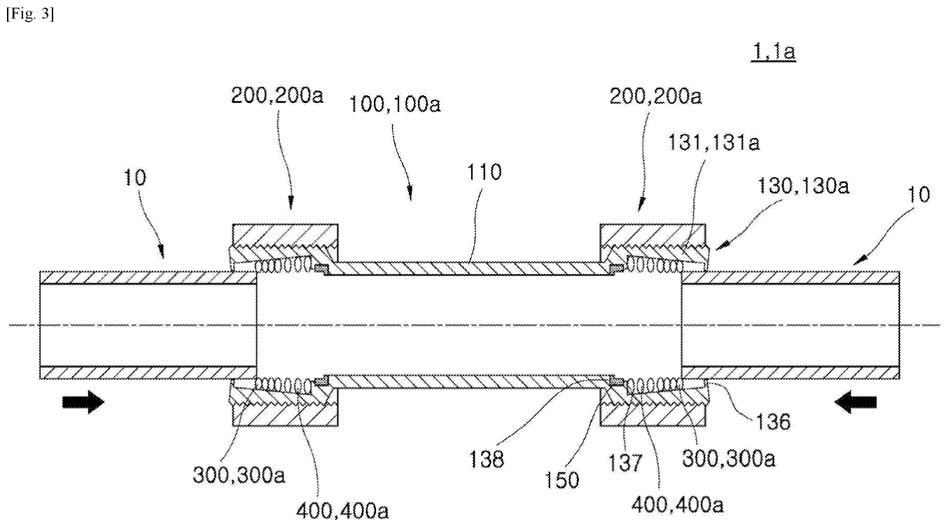

FIG. 1 is an exploded view schematically illustrating a connecting device according to a first embodiment of the present invention, FIG. 2 is a view illustrating a state before a pipe according to the first embodiment of the present invention is inserted into a fixing portion, and FIG. 3 is a view illustrating a state in which the pipe according to the first embodiment of the present invention enters a connecting portion while pushing the fixing portion.

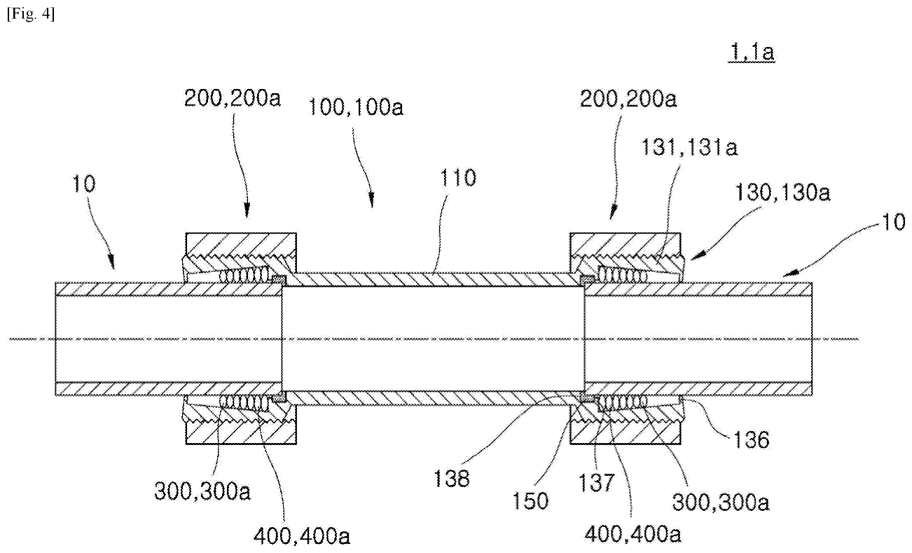

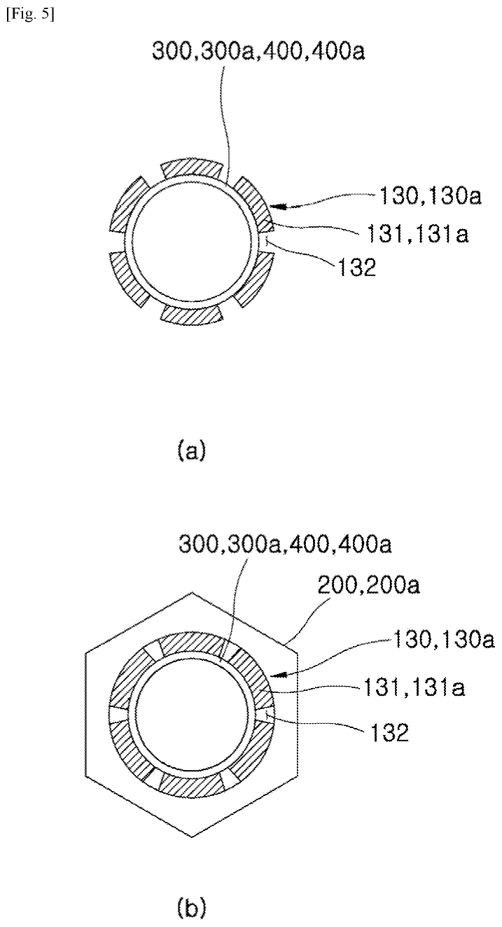

FIG. 4 is a view illustrating a state in which the pipe according to the first embodiment of the present invention is inserted in the fixing portion, and FIG. 5 is a cross-sectional view illustrating before and after a connecting-pressurizing portion according to the first embodiment of the present invention is pressurized by a pressurizing portion.

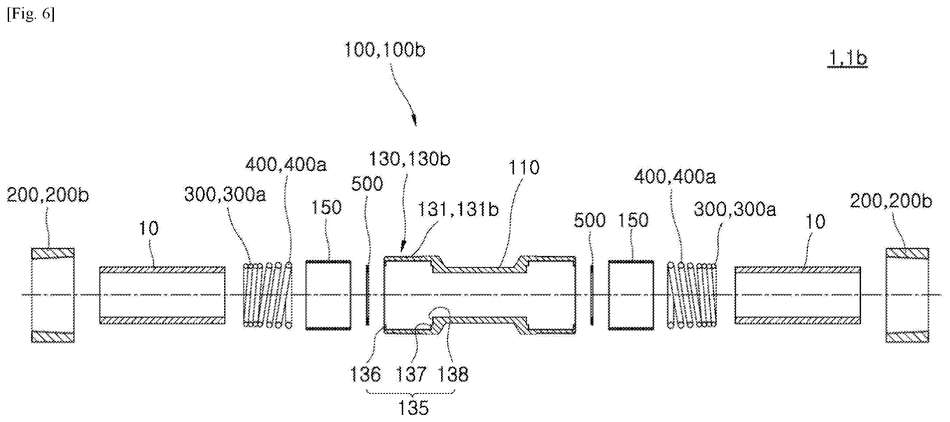

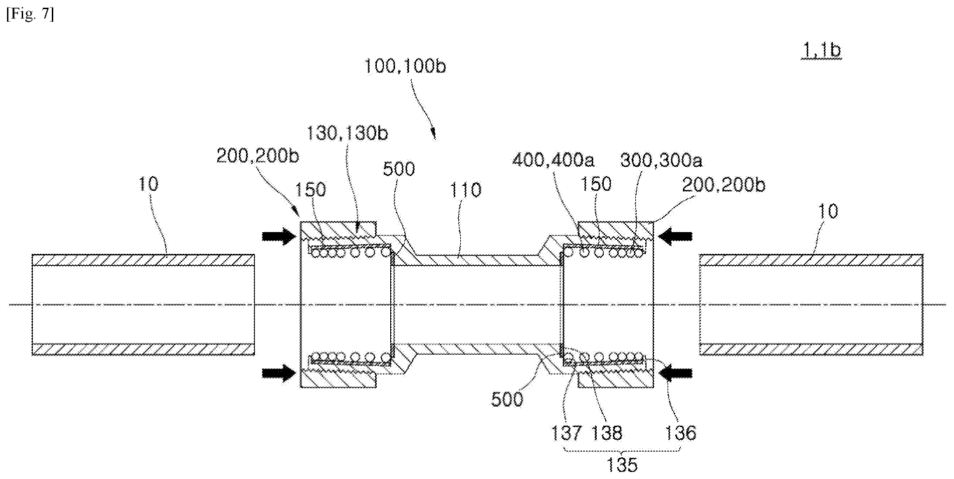

FIG. 6 is an exploded view schematically illustrating a connecting device according to a second embodiment of the present invention, and FIG. 7 is a view illustrating a state before a pipe according to the second embodiment of the present invention is inserted into a fixing portion.

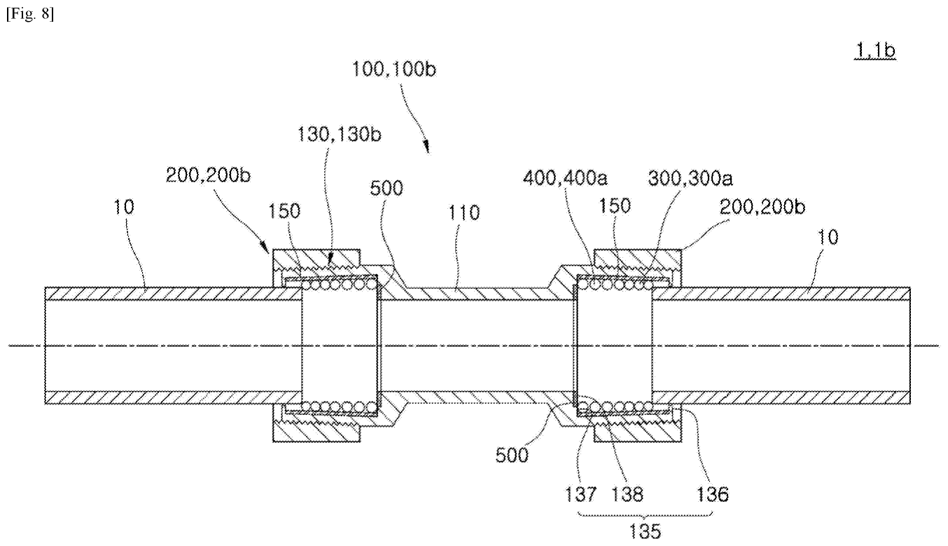

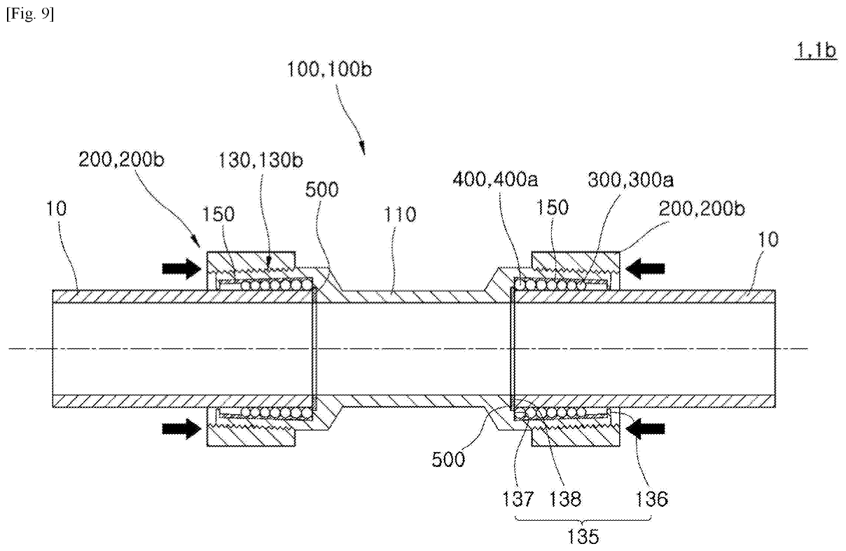

FIG. 8 is a view illustrating a state in which the pipe according to the second embodiment of the present invention enters a connecting portion while pushing the fixing portion, and FIG. 9 is a view illustrating a state in which the pipe according to the second embodiment of the present invention is inserted in the fixing portion.

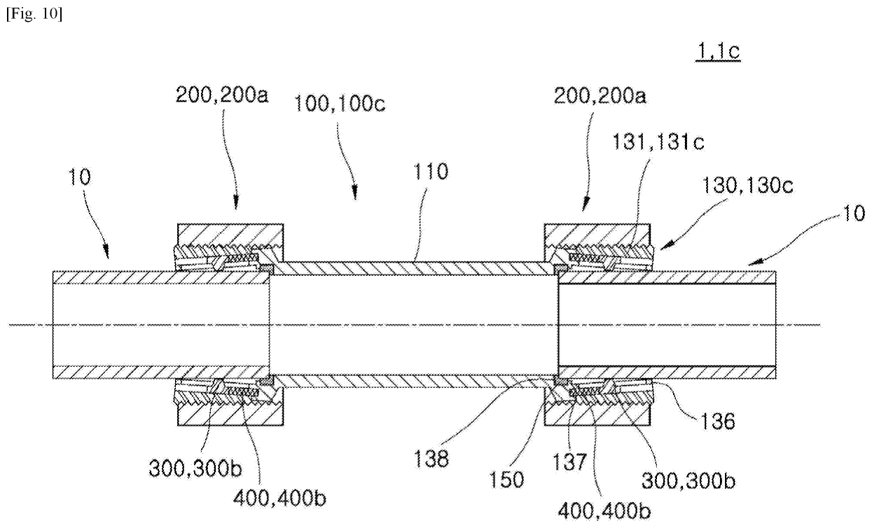

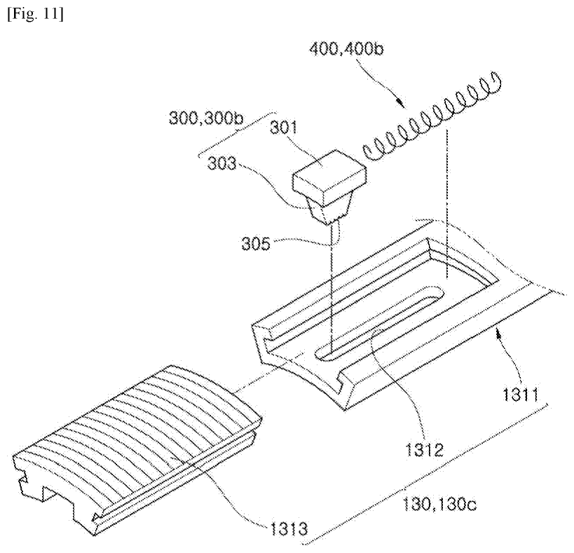

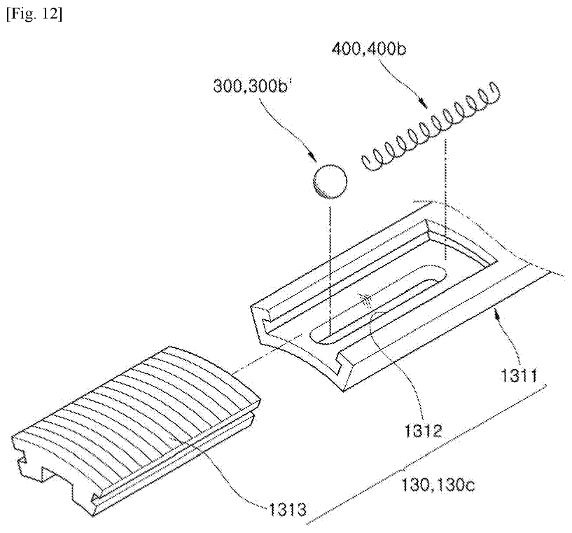

FIG. 10 is a view schematically illustrating a state in which a fixing portion and a supporting portion which are separably provided in a connecting device according to a third embodiment are mounted on a connecting portion, FIG. 11 is a configuration diagram illustrating the fixing portion and the supporting portion which are separably provided in the connecting device according to the third embodiment and the connecting portion, and FIG. 12 is a view illustrating a case in which the fixing portion of the connecting device according to the third embodiment is spherical.

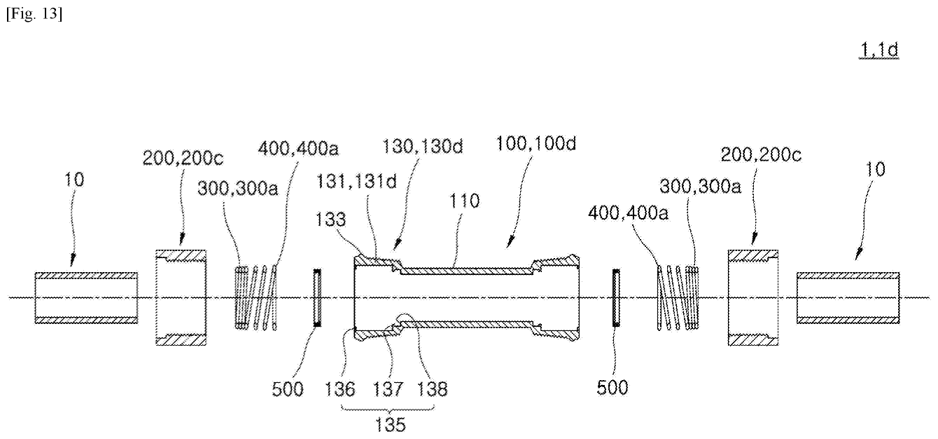

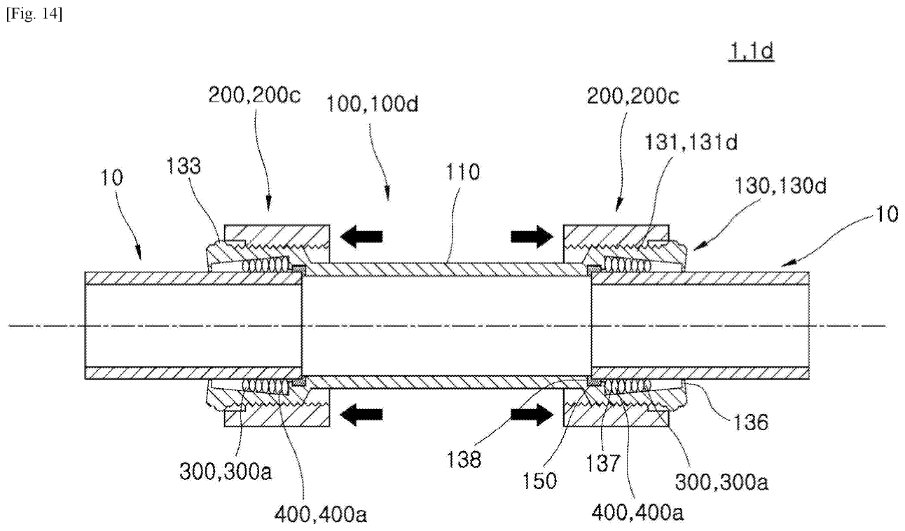

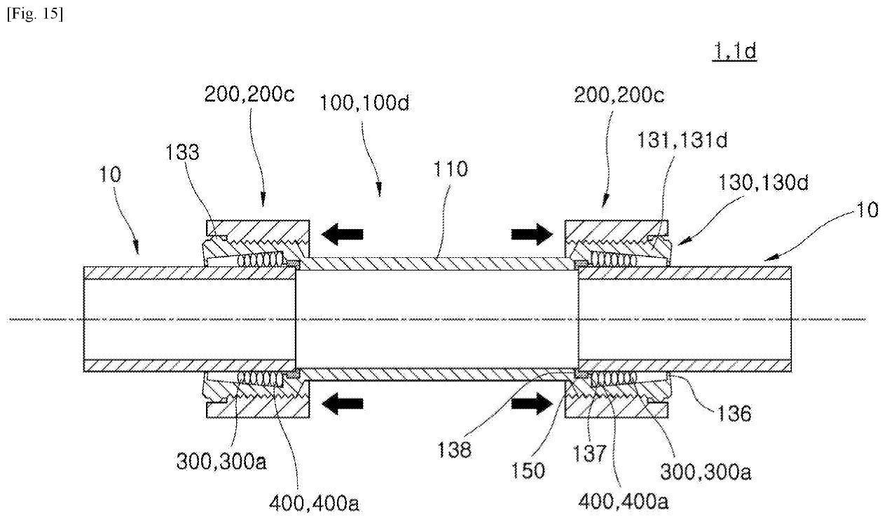

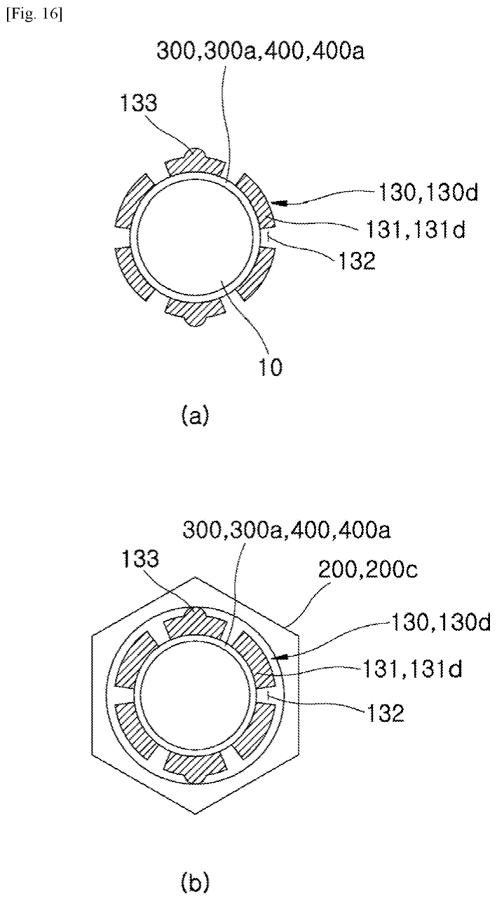

FIG. 13 is a configuration diagram schematically illustrating a connecting device according to a fourth embodiment of the present invention, FIG. 14 is a view illustrating a state in which a pipe is inserted in a fixing portion in the connecting device according to the fourth embodiment of the present invention, FIG. 15 is a view illustrating a state in which a pressuring portion pressurizes a pressurizing protrusion in the connecting device according to the fourth embodiment of the present invention, and FIG. 16 is a cross-section view illustrating before and after a connecting-pressurizing portion according to the fourth embodiment of the present invention is pressurized by the pressurizing portion.

Referring to FIGS. 1 to 16, a connecting device 1, 1a, 1b, 1c, or 1d according to the present invention includes a connection portion 100, 100a, 100b, 100c, or 100d, a pressurizing portion 200, 200a, 200b, or 200c, a fixing portion 300, 300a, 300b, or 300b′, and a supporting portion 400, 400a, or 400b, and one or more pipes 10 and the like are connected thereto.

Here, the pipe 10 refers to a tubular body and the like provided such that a fluid and the like flow therein and may include, for example, a metal tube, a plastic tube, a hose, or the like.

The one or more pipes 10 may be inserted into the connection portion 100, 100b, 100c, or 100d and may be used to extend a length of the pipe 10, to switch a flow of the fluid flowing through the pipe 10, or to diverge a path of the fluid flowing from the one or more pipes 10 into a plurality of paths. In the embodiment, the connection portion 100, 100a, 100b, 100c, or 100d includes a connecting body portion 110 and a connecting-pressurizing portion 130, 130a, 130b, 130c, or 130d.

The connecting body portion 110 is formed to have a tubular shape, in which a space portion such as a through hole, a hollow, and the like is formed so as to receive the fluid and the like from the pipe 10 and to transfer the corresponding fluid to the adjacent pipe 10 and the like.

A cross-sectional shape, a material, a length, and the like of the connecting body portion 110 may vary according to a diameter of the pipe 10 connected by the corresponding connecting device 1, 1a, 1b, 1c, or 1d, an interval between the pipes 10 to be connected, and a temperature, ingredients, and the like of the fluid moved in the pipe 10.

The connecting-pressurizing portion 130, 130a, 130b, 130c, or 130d is coupled to the connecting body portion 110 and is pressurized and deformed by the pressurizing portion 200, 200a, 200b, or 200c according to coupling with the pressurizing portion 200, 200a, 200b, or 200c so as to form a structure in which an advancing side inlet of the pipe 10 is formed to be narrow and an internal space is increased in an advancing direction of the pipe 10.

Here, when the pipe 10 enters, the fixing portion 300, 300a, 300b, or 300b′ and the supporting portion 400, 400a, or 400b are pushed by the pipe 10 and move back according to the connecting-pressurizing portion 130, 130a, 130b, 130c, or 130d and inner diameters of the fixing portion 300, 300a, 300b, or 300b′ and the supporting portion 400, 400a, or 400b increase such that the pipe 10 enters the fixing portion 300, 300a, 300b, or 300b′ and the fixing portion 300, 300a, 300b, or 300b′ located between the pipe 10 and the connecting-pressurizing portion 130, 130a, 130b, 130c, or 130d functions as a wedge for holding the pipe 10.

Here, when a force acts on the pipe 10 in a direction opposite the advancing direction of the pipe 10, since the fixing portion 300, 300a, 300b, or 300b′ moves an incline of the connecting-pressurizing portion 130, 130a, 130b, 130c, or 130d such that the inner diameter of the fixing portion 300, 300a, 300b, or 300b′ is decreased and a strong repulsive force occurs at the fixing portion 300, 300a, 300b, or 300b′ in proportion to the force acting on the pipe 10 which retreats outward, the fixing portion 300, 300a, 300b, or 300b′ may stably and strongly fix the pipe 10.

In the embodiment, while an outer circumferential surface of the connecting-pressurizing portion 130, 130a, 130b, 130c, or 130d is pressurized by the pressurizing portion 200, 200a, 200b, or 200c exemplified as a ring shape, a cross-sectional shape of an inner circumferential surface thereof is configured to become narrower while maintaining approximately a cross-sectional shape of an outer circumferential surface of the fixing portion 300, 300a, 300b, or 300b′, for example, an approximate circular shape when the cross-sectional shape of the outer circumferential surface of the fixing portion 300a is a circular shape in the first embodiment such that the pipe 10 located inside the fixing portion 300a may be pressurized entirely by the fixing portion 300a.

Also, in the embodiment, the connecting-pressurizing portion 130, 130a, 130b, 130c, or 130d is integrally formed with the connecting body portion 110 and includes a metallic material and the like so as to reduce the number of components, the number of assembling processes, and the like to improve durability and the like of the connecting portion 100, 100a, 100b, 100c, or 100d.

Also, in the embodiment, a spiral groove portion or the like corresponding to a shape or a moving path of the fixing portion 300, 300a, 300b, or 300b′ or the supporting portion 400, 400a, or 400b is formed on an inner circumferential surface of the connecting-pressurizing portion 130, 130a, 130b, 130c, or 130d so as to prevent the fixing portion 300, 300a, 300b, or 300b′ or the supporting portion 400, 400a, or 400b from being distorted when the fixing portion 300, 300a, 300b, or 300b′ or the supporting portion 400, 400a, or 400b is pressurized.

Accordingly, an inner distance of the fixing portion 300, 300a, 300b, or 300b, for example, a diameter of an inner circumferential surface thereof varies without distortion so as to stably fix the pipe 10 by pressing against an outer circumferential surface of the pipe 10 which is located therein. Also, the supporting portion 400, 400a, or 400b varies in a diameter and the like without distortion so as to elastically support the fixing portion 300, 300a, 300b, or 300b′ stably.

In the embodiment, the connecting-pressurizing portion 130, 130a, 130b, 130c, or 130d includes a plurality of connecting-pressurizing portion bodies 131, 131a, 131b, 13c, or 131d, is disposed to surround the fixing portion 300, 300a, 300b, or 300b′, and is configured to be spaced apart from another adjacent connecting-pressurizing body portion 131, 131a, 131b, 131c, or 131d.

When the connecting-pressurizing portion 130, 130a, 130b, 130c, or 130d includes the plurality of connecting-pressurizing portion bodies 131, 131a, 131b, 131c, or 131d and an interval is secured between the plurality of connecting-pressurizing portion bodies 131, 131a, 131b, 131c, or 131d, an inner space of the connecting-pressurizing portion bodies 131, 131a, 131b, 131c, or 131d may be reduced while the distortion of the connecting-pressurizing portion bodies 131, 131a, 131b, 131c, or 131d may be maximally reduced when the connecting-pressurizing portion bodies 131, 131a, 131b, 131c, or 131d are pressurized by the pressurizing portion 200, 200a, 200b, or 200c.

In the embodiment, since a degree to which the pressurizing portion 200, 200a, 200b, or 200c pressurizes the connecting-pressurizing portion bodies 131, 131a, 131b, 131c, or 131d varies according to a moving degree of the pressurizing portion 200, 200a, 200b, or 200c, a width of a connecting-pressurizing portion groove portion 132 formed between the connecting-pressurizing portion bodies 131, 131a, 131b, 131c, or 131d varies.

Eventually, when the connecting-pressurizing portion 130, 130a, 130b, 130c, or 130d is pressurized by the pressurizing portion 200, 200a, 200b, or 200c, the width of the connecting-pressurizing portion groove portion 132 is reduced such that the inner diameter of the connecting-pressurizing portion 130, 130a, 130b, 130c, or 130d decreases and the fixing portion 300, 300a, 300b, or 300b′ is pressed against the pipe 10. A variation range of the diameter of the connecting-pressurizing portion 130, 130a, 130b, 130c, or 130d may be increased while preventing the connecting-pressurizing portion 130, 130a, 130b, 130c, or 130d from being damaged or distorted.

In the embodiment, a plurality of such connecting-pressurizing portion groove portions 132 are arranged equidistantly in a circumferential direction on the basis of a longitudinal center of the connecting-pressurizing portion 130, 130a, 130b, 130c, or 130d such that the connecting-pressurizing portion 130, 130a, 130b, 130c, or 130d may be uniformly pressurized and contract when the connecting-pressurizing portion 130, 130a, 130b, 130c, or 130d is pressurized by the pressurizing portion 200, 200a, 200b, or 200c.

In the embodiment, due to a coupling pressure and the like exerted by the pressurizing portion 200, 200a, 200b, or 200c, when the pipe 10 enters, the connecting-pressurizing portion 130, 130a, 130b, 130c, or 130d is deformed to be inclined such that a diameter thereof increases while moving in the advancing direction of the pipe 10.

When the fixing portion 300, 300a, 300b, or 300b′ is pushed by the pipe 10, as the fixing portion 300, 300a, 300b, or 300b′ moving in a longitudinal direction of the connecting-pressurizing portion 130, 130a, 130b, 130c, or 130d moves along the connecting-pressurizing portion 130, 130a, 130b, 130c, or 130d, an inner interval of the fixing portion 300, 300a, 300b, or 300b′ increases.

In the embodiment, a thickness of the fixing portion 300, 300a, 300b, or 300b′ is configured to increase in the advancing direction of the pipe 10 which secures a maximum contact area with the pipe 10 entering inside while coming into contact with or being coupled with the connecting-pressurizing portion 130, 130a, 130b, 130c, or 130d formed to be inclined in the advancing direction of the pipe 10 such that the fixing portion 300, 300a, 300b, or 300b′ stably may fix the pipe 10.

In the embodiment, the pressurizing portion 200, 200a, 200b, or 200c is coupled with the connecting-pressurizing portion 130, 130a, 130b, 130c, or 130d through screw coupling. Here, an inclined surface or the like is formed on the inner circumferential surface of the pressurizing portion 200, 200a, 200b, or 200c or an outer circumferential surface of the connecting-pressurizing portion 130, 130a, 130b, 130c, or 130d such that a degree of the connecting-pressurizing portion 130, 130a, 130b, 130c, or 130d moving toward the pipe 10 side, that is, a rotational central axis of the connecting-pressurizing portion 130, 130a, 130b, 130c, or 130d varies according to a degree of coupling the pressurizing portion 200, 200a, 200b, or 200c with the connecting-pressurizing portion 130, 130a, 130b, 130c, or 130d.

That is, when the degree of coupling the pressurizing portion 200, 200a, 200b, or 200c with the connecting-pressurizing portion 130, 130a, 130b, 130c, or 130d increases, a degree of the connecting-pressurizing portion 130, 130a, 130b, 130c, or 130d being deformed internally increases such that the connecting-pressurizing portion 130, 130a, 130b, 130c, or 130d is moved correspondingly to the fixing portion 300, 300a, 300b, or 300b′. Accordingly, when the fixing portion 300, 300a, 300b, or 300b′ is moved by the supporting portion 400, 400a, or 400b, a force of fixing the pipe 10 by the fixing portion 300, 300a, or 300b may be adjusted by adjusting a degree of the fixing portion 300, 300a, or 300b being moved to be inclined with respect to the longitudinal direction of the pipe 10.

In addition, even when the diameter of the pipe 10 changes within a certain range, the pipe 10 may be fixed by the fixing portion 300, 300a, 300b, or 300b′ by adjusting a position of the fixing portion 300, 300a, 300b, or 300b′ according to the diameter of the pipe 10.

The degree of coupling the pressurizing portion 200, 200a, 200b, or 200c with the connecting-pressurizing portion 130, 130a, 130b, 130c, or 130d may be adjusted using a degree of screw coupling between the pressurizing portion 200, 200a, 200b, or 200c and the connecting-pressurizing portion 130, 130a, 130b, 130c, or 130d.

Also, in order to prevent a separation thereof caused by oscillation of the device, a lapse of time, and the like after coupling between the pressurizing portion 200, 200a, 200b, or 200c and the connecting-pressurizing portion 130, 130a, 130b, 130c, or 130d, mutual movement of the pressurizing portion 200, 200a, 200b, or 200c and the connecting-pressurizing portion 130, 130a, 130b, 130c, or 130d may be prevented by applying a protrusion, a groove, a packing, or the like to a contact surface between the pressurizing portion 200, 200a, 200b, or 200c and the connecting-pressurizing portion 130, 130a, 130b, 130c, or 130d or using a fixing pin or the like.

A variety of embodiments may be applied to the connecting device 1, 1a, 1b, 1c, or 1d according to the embodiment within the technical concept of adjusting a degree of deforming the connecting portion 100, 100a, 100b, 100c, or 100d according to a degree of rotating or moving the pressurizing portion 200, 200a, 200b, or 200c with respect to the connecting portion 100, 100a, 100b, 100c, or 100d.

Referring to FIGS. 1 to 5, in the first embodiment, in the connecting device 1 or 1a, in a state in which an inclined surface is formed outside the connecting-pressurizing portion 130 or 130a and the fixing portion 300 or 300a is mounted on the connecting-pressurizing portion 130 or 130a, the pipe 10 is fixed to the fixing portion 300 or 300a using a method of entering thereinto.

In the first embodiment, an inner diameter of the fixing portion 300 or 300a is formed to be gradually decreased in the advancing direction of the pipe 10 such that the pipe 10 may easily enter into the fixing portion 300 or 300a.

In the first embodiment, the fixing portion 300 or 300a and the supporting portion 400 or 400a are integrally formed and include a metallic material and the like. In the first embodiment, the connecting-pressurizing portion 130 or 130a include a plurality of holding portions 135 formed on an inner surface thereof and located to be spaced apart in the advancing direction of the pipe 10 so as to prevent a separation or the like of the pipe 10, a sealing portion 500, the fixing portion 300 or 300a, the supporting portion 400 or 400a, and the like.

For example, when the plurality of holding portions 135 include a first holding portion 136, a second holding portion 137, and a third holding portion 138 on the basis of a direction in which the pipe 10 enters into the connecting portion 100 or 100a, while the first holding portion 136 supports a rear end portion of the fixing portion 300 or 300a such that a front end of the fixing portion 300 or 300a is coupled with the supporting portion 400 or 400a, the supporting portion 400 or 400a pressurizes the fixing portion 300 or 300a in a direction opposite to a longitudinal advancing direction of the pipe 10 such that the fixing portion 300 or 300a may stably fix the pipe 10.

Also, the second holding portion 137 restricts a degree of the supporting portion 400 or 400a entering into the connecting portion 100, 100a, 100b, 100c, or 100d to restrict a degree to which the supporting portion 400 or 400a moves when the pipe 10 enters. The third holding portion 138 supports the sealing portion 500 such that the sealing portion 500 located between the pipe 10 and the connecting portion 100 or 100a may seal a space between the pipe 10 and the connecting portion 100 or 100a.

The holding portion 135 may be applied not only to the first embodiment but also to the fixing portion 300b or 300b′ and the supporting portion 400b in other embodiments.

In the first embodiment, a connecting-sealing portion 150 and the like including an elastic material is applied between the fixing portion 300 or 300a and the supporting portion 400 or 400a and the connecting portion 100 or 100a so as to prevent a fluid leakage between the connecting portion 100 or 100a and the pipe 10 with the sealing portion 500.

The connecting-sealing portion 150 is applicable not only to the first embodiment but also to other embodiments.

Referring to FIGS. 6 to 9, in the second embodiment, in the connecting device 1 or 1b, an outer diameter of the connecting-pressurizing portion 130 or 130b of the connecting portion 100 or 100b is formed to be approximately uniform while advancing in a direction in which the pipe 10 enters. However, an inner diameter of the pressurizing portion 200 or 200b engaging with the connecting-pressurizing portion 130 or 130b is formed to decrease in the direction in which the pipe 10 enters such that a degree of deforming the connecting-pressurizing portion 130 or 130b, that is, the connecting-pressurizing portion body 131 or 131b toward the pipe 10, increases as a degree of coupling the pressurizing portion 200 or 200b with the connecting-pressurizing portion 130 or 130b increases.

A force of the pipe 10 being pressurized by the fixing portion 300 or 300a located between the connecting-pressurizing portion 130 or 130b and the pipe 10 may be adjusted using that the degree of deforming the connecting-pressurizing portion 130 or 130b toward the pipe 10 is increased according to the degree to which the pressurizing portion 200 or 200b is coupled with the connecting-pressurizing portion 130 or 130b.

FIG. 10 is a view schematically illustrating a state in which the fixing portion and the supporting portion which are separably provided in the connecting device according to the third embodiment of the present invention are mounted on the connecting portion. FIG. 11 is a configuration diagram illustrating the fixing portion and the supporting portion which are separably provided in the connecting device according to the third embodiment of the present invention and the connecting portion. FIG. 12 is a view illustrating a case in which the fixing portion of the connecting device according to the third embodiment of the present invention is spherical.

Referring to FIGS. 10 to 12, in the connecting device 1 or 1c according to the third embodiment of the present invention, a plurality of such fixing portions 300, 300b, or 300b′ are provided to be coupled with the connecting-pressurizing portion 130 or 130c of the connecting portion 100 or 100c and each are movably provided at the connecting-pressurizing portion 130 or 130c to pressurize and fix the pipe 10.

According to one embodiment of the fixing portion 300, 300b, or 300b′, the fixing portion 300, 300b, or 300b′ may include a fixing-moving portion 301 movably provided while being inserted in the connecting-pressurizing portion body 131 or 131c of the connecting-pressurizing portion 130 or 130c and pressurized by the supporting portion 400 or 400b and a pipe-contacting portion 303 configured to protrude from the fixing-moving portion 301 and to come into contact with an outer circumferential surface of the pipe 10.

The pipe-contacting portion 303 may include a pipe-contacting protrusion portion 305 formed to protrude from a surface facing the pipe 10 and increase a contact force and the like with the pipe 10.

In another embodiment, the fixing portion 300 or 300b′ is exemplified as a sphere, an ellipse, and the like including a convexly curved surface toward the pipe 10 and may pressurize and fix the pipe 10.

To support the fixing portion 300, 300b, or 300b′, the connecting-pressurizing portion 130 or 130c is provided such that the fixing portion 300, 300b, or 300b′ is movable and may be configured to include a fixing portion accommodating portion 1311 in which a fixing portion through hole portion 1312 is formed such that a convex part of the fixing portion 300, 300b, or 300b′, for example, the pipe-contacting portion 303 and the like may pass therethrough and come into contact with the pipe 10 and an accommodating cover portion 1313 which prevents the fixing portion 300, 300b, or 300b′ from being separated from the fixing portion accommodating portion 1311 and is coupled with the pressurizing portion 200 or 200a using a screw.

FIG. 13 is a configuration diagram schematically illustrating the connecting device according to the fourth embodiment of the present invention, FIG. 14 is a view illustrating a state in which the pipe is inserted in the fixing portion in the connecting device according to the fourth embodiment of the present invention, FIG. 15 is a view illustrating a state in which the pressuring portion pressurizes a pressurizing protrusion in the connecting device according to the fourth embodiment of the present invention, and FIG. 16 is a cross-section view illustrating before and after the connecting-pressurizing portion according to the fourth embodiment of the present invention is pressurized by the pressurizing portion.

Referring to FIGS. 13 to 16, in the fourth embodiment, in the connecting device 1 or 1d, the connecting-pressurizing portion 130 or 130d of the connecting portion 100 or 100d may further include a pressurizing protrusion 133. The pressurizing protrusion 133 protrudes outward from the connecting-pressurizing portion body 131 or 13d and comes into an inner circumferential surface of the pressurizing portion 200 or 200c and is pressurized according to movement of the pressurizing portion 200 or 200c such that a degree of deforming the connecting-pressurizing portion body 131 or 131d toward the pipe 10 is increased.

Accordingly, even when oscillation of the device, a change in a pressure of a fluid passing through the pipe 10, or the like occurs, the pressurizing protrusion 133 restricts the fixing portion 300 or 300a from being moved with respect to the pipe 10 such that the fixing portion 300 or 300a may stably fix the pipe 10.

In the fourth embodiment, the pressurizing protrusions 133 are arranged equidistantly in a circumferential direction on the basis of a central axis of the fixing portion 300 or 300a or the supporting portion 400 or 400a so as to prevent the pipe 10 from being eccentric toward one side due to interference of the pressurizing protrusion 133 and the pressurizing portion 200 or 200c.

The pressurizing protrusion 133 may be applied to other embodiments. In the embodiment, the supporting portion 400, 400a, or 400b may stably fix the pipe 10 using a method of elastically pressurizing the fixing portion 300, 300a, 300b, or 300b′ in a direction opposite to the direction in which the pipe 10 enters into the fixing portion 300, 300a, 300b, or 300b′ such that the fixing portion 300, 300a, 300b, or 300b′ pressurizes the pipe 10 between the connecting portion 100, 100a, 100b, 100c, or 100d and the pipe 10 according to a wedge action.

In the embodiment, the fixing portion 300, 300a, 300b, or 300b′ and the supporting portion 400, 400a, or 400b may be formed to have a coil shape and be integrally formed so as to reduce the number of components and to improve an assembling property and the like (refer to FIGS. 1 to 9 and 13 to 16) or may be separately formed so as to increase a range of a change in a diameter of the pipe 10 which may enter thereinto (refer to FIGS. 10 to 12).

The pressurizing portion 200, 200a, 200b, or 200c pressurizes the connecting portion 100, 100a, 100b, 100c, or 100d such that the connecting portion 100, 100a, 100b, 100c, or 100d tilts toward a center of the pipe 10 in a longitudinal direction. The fixing portion 300, 300a, 300b, or 300b′ is mounted on the connecting portion 100, 100a, 100b, 100c, or 100d. When the connecting portion 100, 100a, 100b, 100c, or 100d is deformed by the pressurizing portion 200, 200a, 200b, or 200c, the fixing portion 300, 300a, 300b, or 300b′ is pressurized toward the pipe 10 and restricts movement of the pipe 10 with respect to the connecting portion 100, 100a, 100b, 100c, or 100d.

The supporting portion 400, 400a, or 400b is connected to the fixing portion 300, 300a, 300b, or 300b′ and pressurizes the fixing portion 300, 300a, 300b, or 300b′ such that the fixing portion 300, 300a, 300b, or 300b′ may fix the pipe 10 due to a wedge action and the like. In the embodiment, the supporting portion 400, 400a, or 400b is exemplified as a coil spring or the like and elastically supports the fixing portion 300, 300a, 300b, or 300b′.

Hereinafter, an operating principle and effects of the connecting device 1, 1a, 1b, 1c, or 1d according to one embodiment of the present invention will be described as follows.

First, the sealing portion 500, the fixing portion 300, 300a, 300b, or 300b′, and the supporting portion 400, 400a, or 400b are mounted on the connecting-pressurizing portion 130, 130a, 130b, 130c, or 130d.

To prevent the sealing portion 500, the fixing portion 300, 300a, 300b, or 300b′, and the supporting portion 400, 400a, or 400b from being separated from the connecting body portion 110, 100a, 100b, 110c, or 110d after they are inserted thereinto, the sealing portion 500, the fixing portion 300, 300a, 300b, or 300b′, and the supporting portion 400, 400a, or 400b may be restricted in movement thereof by the holding portion 135, the accommodating cover portion 1313, or the like.

When the sealing portion 500, the fixing portion 300, 300a, 300b, or 300b′, and the supporting portion 400, 400a, or 400b are mounted on the connecting-pressurizing portion 130, 130a, 130b, 130c, or 130d, the pressurizing portion 200, 200a, 200b, or 200c is fastened to the connecting-pressurizing portion 130, 130a, 130b, 130c, or 130d such that a movement direction of the fixing portion 300, 300a, 300b, or 300b′ becomes a direction of being separated from a rotation axis of the connecting-pressurizing portion 130, 130a, 130b, 130c, or 130d in a direction in which the pipe 10 enters.

Particularly, an inner diameter D1 of one end formed by the fixing portion 300, 300a, 300b, or 300b′ is greater than an outer diameter D2 of the pipe 10 due to fastening of the pressurizing portion 200, 200a, 200b, or 200c to the connecting-pressurizing portion 130, 130a, 130b, 130c, or 130d such that, when the pipe 10 enters, an entering front end of the pipe 10 may enter into the connecting portion 100, 100a, 100b, 100c, or 100d while pushing the fixing portion 300, 300a, 300b, or 300b′.

However, when the fixing portion 300, 300a, 300b, or 300b′ mounted on the connecting-pressurizing portion 130, 130a, 130b, 130c, or 130d is pressurized by the pipe 10 and moves along a longitudinal direction of the connecting-pressurizing portion 130, 130a, 130b, 130c, or 130d, an inner diameter of the fixing portion 300, 300a, 300b, or 300b′ or a distance between the fixing portion 300, 300a, 300b, or 300b′ and a center of the connecting-pressurizing portion 130, 130a, 130b, 130c, or 130d in an axial direction increases according to an incline of the connecting-pressurizing portion 130, 130a, 130b, 130c, or 130d such that the pipe 10 is inserted into the fixing portion 300, 300a, 300b, or 300b′ as the corresponding inner diameter or distance increases.

The pipe 10 advances further while being inserted into the fixing portion 300, 300a, 300b, or 300b′ such that the entering front end comes into contact with the sealing portion 500.

The fixing portion 300, 300a, 300b, or 300b′ pressurized by the pipe 10 is elastically supported by the supporting portion 400, 400a, or 400b compressed according to the movement of the fixing portion 300, 300a, 300b, or 300b′ and enters into a gap between the connecting portion 100, 100a, 100b, 100c, or 100d and the pipe 10 to cause a wedge effect such that the pipe 10 is pressurized and fixed.

The fixing portion 300, 300a, 300b, or 300b′ or the sealing portion 500 comes into contact with the pipe 10 and fixes the pipe 10. In addition thereto, a force of the fixing portion 300, 300a, 300b, or 300b′ pressurizing and fixing the pipe 10 may be increased by increasing a degree of deforming the connecting-pressurizing portion 130, 130a, 130b, 130c, or 130d by moving the pressurizing portion 200, 200a, 200b, or 200c.

Also, in the embodiment, since a degree to which the pressurizing portion 200, 200a, 200b, or 200c pressurizes the connecting-pressurizing portion 130, 130a, 130b, 130c, or 130d may be further increased when the pressurizing protrusion 133 is formed at the connecting-pressurizing portion 130, 130a, 130b, 130c, or 130d, the force of the fixing portion 300, 300a, 300b, or 300b′ fixing the pipe 10 may be increased.

The pipe 10 may be separated from the connecting portion 100, 100a, 100b, 100c, or 100d using a simple method of reducing the force by which the fixing portion 300, 300a, 300b, or 300b′ pressurizes and fixes the pipe 10 by releasing the fastening between the pressurizing portion 200, 200a, 200b, or 200c and the connecting-pressurizing portion 130, 130a, 130b, 130c, or 130d and then removing the pipe 10 from the connecting portion 100, 100a, 100b, 100c, or 100d.

Therefore, the connecting device 1, 1a, 1b, 1c, or 1d according to the embodiment is implemented using a simple configuration such that there are present effects of easily manufacturing the connecting device 1, 1a, 1b, 1c, or 1d, decreasing manufacturing costs thereof, and detaching or attaching the pipe 10 using a simple operation.

Although the present invention has been described with reference to the embodiments shown in the drawings, it should be understood that the embodiments are merely examples, and a variety of modifications and equivalents thereof may be made by one of ordinary skill in the art. Accordingly, the technical scope of the present invention will be defined by the following claims.

1. A connecting device comprising:
a connecting portion provided such that a pipe is insertable thereinto;
a pressurizing portion configured to deform the connecting portion by pressurizing the connecting portion;
a fixing portion mounted on the connecting portion, moved by the pipe when the pipe is inserted into the connecting portion, and configured to come into contact with the pipe; and
a supporting portion configured to pressurize the fixing portion such that the fixing portion restricts movement of the pipe.

2. The connecting device of claim 1, wherein the connecting portion comprises:
a connecting body portion, which includes a space portion therein and is connected to the pipe; and
a connecting-pressurizing portion coupled with the connecting body portion, on which the fixing portion is mounted, deformed according to coupling with the pressurizing portion, and formed such that an inner diameter of the fixing portion extends as the fixing portion moves in a direction in which the pipe enters.

3. The connecting device of claim 2, wherein the connecting-pressurizing portion comprises a plurality of connecting-pressurizing portion bodies, which are disposed to be spaced apart, on which the fixing portion is mounted, and
wherein the connecting-pressurizing portion body is provided such that an interval from another connecting-pressurizing portion body adjacent thereto varies according to a degree of the pressurizing portion moving.

4. The connecting device of claim 3, wherein the connecting-pressurizing portion further comprises a pressurizing protrusion protruding outward from the connecting-pressurizing portion body and moves the connecting-pressurizing portion body inward when the pressurizing protrusion is pressurized according to movement of the pressurizing portion.

5. The connecting device of claim 4, wherein the pressurizing protrusions are equidistantly arranged in a circumferential direction on the basis of a central axis of the fixing portion or the supporting portion.

6. The connecting device of claim 2, wherein the fixing portion is provided to be movable at the connecting-pressurizing portion, protrudes from the connecting-pressurizing portion, and comes into contact with the pipe.

7. The connecting device of claim 6, wherein the fixing portion comprises:
a fixing-moving portion movably provided at the connecting-pressurizing portion and pressurized by the supporting portion; and
a pipe-contacting portion protruding from the fixing-moving portion and coming into contact with an outer circumferential surface of the pipe.

8. The connecting device of claim 7, wherein the pipe-contacting portion comprises a pipe-contacting protrusion portion formed to protrude from a surface facing the pipe and comes into contact with the pipe.

9. The connecting device of claim 7, wherein the connecting-pressurizing portion comprises:
a fixing portion accommodating portion in which the fixing-moving portion is movable and through which the fixing portion passes; and
an accommodating cover portion coupled with the fixing portion accommodating portion and configured to prevent the fixing portion from being separated from the fixing portion accommodating portion.

10. The connecting device of claim 6, wherein the fixing portion comprises a convex surface coming into contact with the pipe and formed as a curved surface.

11. The connecting device of claim 1, wherein a thickness of the fixing portion is formed to increase in a direction in which the pipe enters.

12. The connecting device of claim 1, wherein the fixing portion and the supporting portion are integrally formed.

13. The connecting device of claim 12, wherein the fixing portion and the supporting portion are formed to separately have a coil shape.

14. The connecting device of claim 1, wherein the supporting portion pressurizes the fixing portion in a direction opposite to the direction in which the pipe enters into the fixing portion.
